(19) United States
(12) Patent Application Publication
(10) Pub. No.: US 2011/0001665 A1
(43) Pub. Date: Jan. 6, 2011

(54) Camera Radio Signal Operation Based on Global Positioning

(75) Inventor: Kevin James King, Vancouver, WA (US)

Correspondence Address: Leap Devices, LLC, Suite 100, 501 SE Columbia Shores Blvd, Vancouver, WA, 98661, US

(73) Assignee: Leap Devices, LLC

(21) Appl. No.: 12/830,184

(22) Filed: Jul. 2, 2010

Related U.S. Application Data
(60) Provisional application No. 61/222,832, filed on Jul. 2, 2009.

(51) Int. Cl. G01S 19/42

(52) U.S. Cl. 342/357.25; 342/385

(57) ABSTRACT

Methods and by which a radio signal transmitter of a photographic device may be configured to adhere to the local legal and regulatory limits of a specific region based on a locational fix data derived from a global positioning system GPS receiver of the photographic device.

### CROSS REFERENCES TO RELATED APPLICATIONS

This application claims the benefit of U.S. Provisional Patent Application No. 61/222,832 filed Jul. 2, 2009, titled “Camera Radio Signal Operation Based on Global Positioning”, and incorporates the disclosure of that application by reference.

### SUMMARY OF THE INVENTION

In various representative aspects, the present invention includes a radio signal receiver which is able to receive one or more of a radio signal which may be used to substantially estimate the physical geographic location of the radio signal receiver on the Earth for example, a Global Positioning System (“GPS”) receiver which may allow an electronic device (such as for example, a camera system used for photography, videography, control of lighting, etc) comprising a GPS receiver to substantially estimate the physical geographic location of the electronic device on the Earth. The estimated physical location on the earth may be used to configure one or more operational parameters of a radio signal transmitter which the electronic device may also comprise and use to communicate wirelessly via radio signals with an at least second device, such that the one or more operational parameters may correspond to the legally allowable radio signal transmitting parameters for a radio signal transmitter in a given locality, which may be matched based on the estimated physical location of the estimated physical location on the earth.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 representatively illustrates a conceptual diagram of the earth, having satellites, which are able to transmit radio signals by which a location fix on the earth may be obtained;

FIG. 2 representatively illustrates one of many conceivable camera systems which may have embodied the present invention;

FIG. 3 representatively illustrates an exemplary simplified block diagram of the internals of a device which may have embodied the present invention.

Elements and steps in the figures may be illustrated for simplicity and clarity and have not necessarily been rendered according to any particular sequence. For example, steps that may be performed concurrently or in different order may be illustrated in the figures to help improve understanding of embodiments of the present invention.

Background

There are many situations in various forms of photography where it is desirable by a photographer to position lighting equipment in such a way that running cables to that lighting equipment is inconvenient or not possible. There is therefore a need and desire among photographers to have various wireless means of control and activation of their lighting and camera equipment. It is also desirable to provide wireless communication via radio signal as opposed to other wireless signaling means such as optical or light based signals, as radio signals travel long distances and do not require a clean optical line of sight between wireless devices to communicate.

In the field of camera and camera system manufacturing, it may be difficult or expensive to manufacture multiple models of cameras or camera accessories which have the ability to transmit radio signals such that the multiple models may be distributed to different areas of the world having differing standards and legalities regarding the transmission of radio signals.

For example, a manufacturer of a camera or camera accessories may need to produce a model of camera having ability to transmit radio signals to accessory devices adhering to radio signal regulations in a particular country or locality of export, such as the United States and Canada, for example, using the 902 MHz to 928 MHz ISM band, while they may need to produce a second model of the same camera having ability to transmit radio signals to accessory devices meeting regulations for European countries—countries in which the 902-928 MHz band may not be allowed for this type of use, but the 869 MHz band may be allowed instead.

Present Invention

The present invention is a method and system which solves the problem of global supply of photographic electronics to markets having varied local regulations for radio devices.

Several current market camera systems may have designed into the camera or available as an accessory, a hardware capable of receiving signals from satellites of the global positioning system (“GPS”). The GPS functionality is useful to photographers in that the exact location a photograph was taken may be recorded and possibly even including the direction the photographer was facing. This locational data may be stored in the EXIF information or other data embedded in or with a digital photograph. The information may be useful to later database or management systems to know the location on the earth where the photograph was taken. It is expected that GPS reception functionality will eventually be implemented in consumer digital cameras also as the cost of GPS reception technology is falling rapidly.

The GPS reception hardware already present in a camera system or GPS reception hardware which can be added as an accessory to the camera system which is in communication with the camera system may provide information to the camera system as to the approximate location on the earth of the camera system.

A number of local areas, countries, continents, towns, municipalities, specific locations such as military installations, demolition blasting areas, and the like may be identified as a list of one or more regions, and that list of regions along with the geographic confines of those regions may be known to the camera system from an external source or programmed internally to the camera system or portion of the camera system which is able to record, store, search, or recall said geographic region information.

A camera system may be programmed with this list of regions or otherwise made accessible to a list of regions. The camera system may then relate a given GPS fix data to being within the confines of a specific region. The camera system may then configure a radio communications system which may comprise a radio signal transmitter to operate within the legal regulatory limits of the specific region.

Method

A radio communications system operated within or combined with a camera system, or an electronic device such as but not limited to a camera flash unit, or an electronic accessory device such as but not limited to a light meter, camera positioning device, and the like, used in the field of still or motion photography or cinematography, these together, individually, or in any combination thereof a “photographic device” or “photographic devices”; providing useful utility by using a wireless communication capability such as that which may be provided by a radio communications system may be designed to operate a radio communications system which may have set one or more various parameter or parameters.

A radio communications system (hereafter may be referred to in this disclosure as “RCS”) may comprise one or more of a radio signal transmitter (hereafter may be referred to in this disclosure simply as “transmitter”) which may include an antenna element for emitting radio signals into free space. An RCS may be electrically coupled to a photographic device via an accessory port of the photographic device, a specialized connector of a photographic device, a general use port of the photographic device (such as but not limited to a USB port or connector of a photographic device). An RCS may additionally or in place of the former, may be comprised substantially within the housing or enclosure of a photographic device. For example, an RCS may be comprised substantially on a printed circuit board or accessory printed circuit board which may comprise additional circuitry for other unrelated operations of the photographic device. In any case, an antenna element of an RCS may be substantially located internal to the housing of a photographic device, or externally to the housing of a photographic device, or added to a connector which may be present on the exterior of a photographic device.

A camera system may comprise one or more of a photographic device or photographic devices, and wherein the various photographic devices comprising the camera system may be able to communicate one or more signals between each other via a variety of means such as but not limited to electrically coupling devices via connectors, cords, or cables, the sending of signals such as optical signals which may include pulsed light data signals, the sending and/or receiving of one or more of a radio signal between the various photographic devices of a camera system, such as for example, by using one or more RCS of the camera system. A camera system may comprise one or more of an RCS.

A parameter of an RCS may include but may not be limited to, the radio frequency at which to transmit, the amount of output power that should be used to radiate the radio frequency into free space, the maximum duty cycle of the radio frequency, the way data or control signals should be formatted when modulated or keyed by the radio frequency, and so on.

It is therefore possible to design a given photographic device which has included or coupled thereto one or more radio communication systems, a configuration of one or more antenna elements, and one or more methods of configuring at least one parameter, and has the ability to select one or more of each based on some indication, signal, or value.

As a given photographic device may already have a GPS reception ability, or a device having a GPS reception ability may be easily coupled to a given photographic device, it is easily implemented that a value provided by the GPS reception ability is related to a physical location on the earth (this hereafter in the present specification may be referred to as a “locational fix”) of the photographic device. A photographic device may then relate a locational fix to a list of one or more regions, and each region may relate to one or more of a specific parameter or parameters that may be used to configure an RCS of the photographic device, and wherein two different regions may relate to different values of a specific parameter or parameters that may be use to configure an RCS of the photographic device. A given parameter or parameters which may be related to or correspond to a given region may, when used to configure an RCS of the photographic device may causes the RCS of the photographic device to operate within the legal regulatory limits of the given region.

Mapping Regions

A region may describe a geographic area on the earth of any size or shape, and wherein a boundary may be enclose the region on all sides, and wherein a boundary may indicate the point at which a locational fix is found to be inside a region, or the point at which a locational fix is found to be outside a region. A region may correspond to, for example, the national boarder of a country, city, locality, continent, international oceans, or any other conceivable geographic area on or above the earth which may be enclosed by some geographic boundary. The boundary of a region may be referred to throughout the present specification as a “geo-fence”.

Each of one or more of a region may have related to it various parameters for configuring an RCS of a photographic device or one or more devices comprising a camera system.

It is considered also that there may be geographic locations on the earth where it is not legal to transmit radio signals, for example, certain countries may not allow the transmission of radio signals by certain users at all. Additionally, in some countries, localities, or regions, there may be specific geographic areas where it is not safe or desirable or legally allowable to transmit radio signals, for example, in the close vicinity of demolition or blasting areas where explosives may be used, and wherein the transmitting of radio signals may pose a danger, near or around certain government or military installations, and the like. It is therefore considered that a region may correspond to an “exclusion area”. If a locational fix is related to a region which is an exclusion area, is may be possible to configure an RCS of a photographic device to become non-operational and to not allow the transmission of radio signals while inside the exclusion area, or to only transmit radio signals at a significantly reduced power level while inside the exclusion area, etc.

Getting a Location

When a photographic device having a GPS reception ability is activated or turned on or at some other appropriate time prior to activating a radio communication system, the photographic device may attempt to begin reception of signals from one or more satellites of the GPS system. Once enough GPS signals are received, a GPS receiver may provide a data which may be related to a locational fix to the photographic device.

It is considered that alternately or in addition to the method of GPS location fixing described above, it may be possible to substantially determine a locational fix or at least an estimated location on the earth based on reception of other characteristic radio signals which may be characteristically present in a given region. For example by not limited to, scanning for a radio transponder indicating a given cellular phone service is operating in the area, by referencing the identification numbers of a cellular tower or towers to which an RCS or other radio signal receiver of a photographic device is perceptible of, triangulating one or more navigational beacons (such as but not limited to those used for marine and aircraft navigation), reading the station identifiers of television or music radio stations present, or any other reception of any other signal or phenomenon which is present and perceptible to a photographic device or a circuitry of a photographic device which may be characteristic of a specific location, area, or region on the earth.

Construction and Implementation

A photographic device may be designed to include within, or have retrofitted to internally or externally, or have a device attached or controlled externally to a photographic device, having one or more radio signal transmitters, radio signal receivers, or radio signal transceivers including any required frequency oscillators, crystals, or clock sources, which set a radio signal transmission or reception frequency, or an intermediate frequency used as a basis to set a radio transmission or reception frequency via a phase locked loop “PLL” or other appropriate means, or a clocking or frequency source provided by other circuitry within or external to the photographic device which also supplies a clock source or frequency to other circuitry used by the photographic device, and also including any required antenna elements, antenna tuning elements, balun filters, or the like, these collectively, individually, or in any combination there-of comprising a “radio system” or a “radio system of the photographic device”, as well as a power supply source supplied by the photographic device or another power source not associated with powering the photographic device which is able to power the radio system, as well as one or more means by which the photographic device may communicate signals to and/or from a radio system including any combination of one or more means by which the radio system may be turned on or off, and/or one or more means of configuring transmission parameters of a radio system.

In the most simple application, a photographic device may have a radio system which is able to operate using a single configuration of transmission parameters, and that photographic device has a means of enabling or disabling the operation of the radio system. In this case, for example, the radio system may be legally operated using the single configuration of transmission parameters in a single region on the earth or multiple regions on the earth which provide compatible legalities and regulations for the operation of the radio system. For example, the single set of transmission parameters may include those specifications outlined by part 15.247 of the FCC regulations, and as such, the radio system may be legally operated within the geographic confines of the United States, but may not be legally operated outside the geographic confines of the United States. In most cases, the regulations relating to the operation of radio systems for Canada are identical to those of the United States. Assuming the proper documentation is filed with Industry Canada, the radio system having the same single configuration of transmission parameters adhering to the part 15.247 FCC regulations would also be legally operated within the geographic confines of Canada.

In the preceding example, if a locational fix is determined to place the photographic device having a radio system within the geographic confines of the United States or Canada, the photographic device would enable the radio system allowing for wireless communication between the photographic device and other wireless devices or equipment. If a locational fix is determined to place the photographic device having a radio system outside the geographic confines of the United States or Canada, the photographic device would disable the radio system such that it produces no intentional radio signals.

Such an implementation would allow a single photographic device or “skew” to be manufactured and distributed globally. Any photographer who is physically located within the geographic confines of the United States or Canada would have wireless communication capability by radio signals of the photographic device, and if a photographer took the same photographic device to Europe, the photographic device would not emit any radio signals and would not provide a wireless communication capability by radio signals. The same device or skew could be shipped to countries specifically banning or outlawing the operation of intentional radio transmitters without violating any local regulatory laws as the photographic device would never enable the radio system as any locational fix obtained by the photographic device will not be found to locate the photographic device inside the United States or Canada.

It is possible also to design and implement a system and method as that previously described which provides a means by which a photographic device can configure a radio system or multiple radio systems in such a way that the photographic device can communicate via radio signals compatible with a plurality of local regulations corresponding to a plurality of regions, even if one or more of the plurality of local regulations or regions is incompatible with another of the local regulations or regions.

For example the radio system may be capable of communication via radio signals compatible with specifications of part 15.247 of the FCC regulations, and is also able via switching means or programmatically to configure the radio system or a second radio system to communicate via radio signals which are compatible with the CE directives and harmonized standards adopted by most European countries.

In such example, if a locational fix is obtained by the photographic device which corresponds to the photographic device being inside the geographic confines of the United States or Canada, the radio system is configured to communicate using those parameters compatible with 15.247 of the FCC regulations; and if instead a locational fix is obtained by the photographic device which corresponds to the photographic device being inside the geographic confines of a country or locality within Europe which has adopted the applicable CE harmonized standards, the radio system is configured to communicate using those parameters compatible with the applicable CE harmonized standards.

It is possible in any given example where a locational fix is obtained which is not within a geographic area or region for which the radio system is legally certified, or the locational fix corresponds to a geographic area or region where the use of a radio communication system is specifically prohibited. In such a case, the one or more radio systems of the photographic device are disabled and will not transmit radio signals.

Alterations and Additional Logic

There may be certain situations where it is not possible to receive a locational fix such as for example when a photographic device is being operated inside a building which does not allow for radio signals or GPS signals to enter the building or be received at a sufficient level to allow a photographic device to achieve a locational fix.

To alleviate this possibility, it is possible to design a photographic device to continually or periodically receive a new locational fix or update a previous locational fix, even if the power is turned off to the photographic device by drawing a minimal current from a power supply present inside the photographic device or external to the photographic device, or from a backup power supply such as but not limited to a battery used to power the system for achieving and storing a locational fix which may or may not also provide primary power or backup power to other devices within the camera system or photographic device.

It is therefore possible for the photographic device to be configured in such a way as to allow operation of a radio system within the legal and regulatory parameters of the region corresponding to the last known locational fix. It is also possible in a similar way to reference a period of time for which a locational fix is valid, or a time delay in minutes, hours, days, etc, which when expired without achieving a new or updated locational fix will disable the radio system until a new or updated locational fix is obtained. It is also possible to design a method of achieving a locational fix which obtains said locational fix without the action, authorization, knowledge, or consent of a user of the photographic device.

Using the above methods, it is unlikely or impossible for a photographic device to for example acquire a locational fix to allow operation of a radio system in one region, then for the photographic device to be placed on an airplane and travel to a new region which does not allow the operation of a radio system, and for the photographic device to still operate a radio system in the new region based on a locational fix obtained in the previous region.

In this example, a photographic device placed inside luggage or a camera bag would likely receive GPS signals or other phenomenon by which a locational fix may be derived within seconds of being moved outside the outer skin of an aircraft, and thus would be able to configure the radio system for the new region before it could possibly be used or powered on by a user.

### DETAILED DESCRIPTION OF DRAWINGS

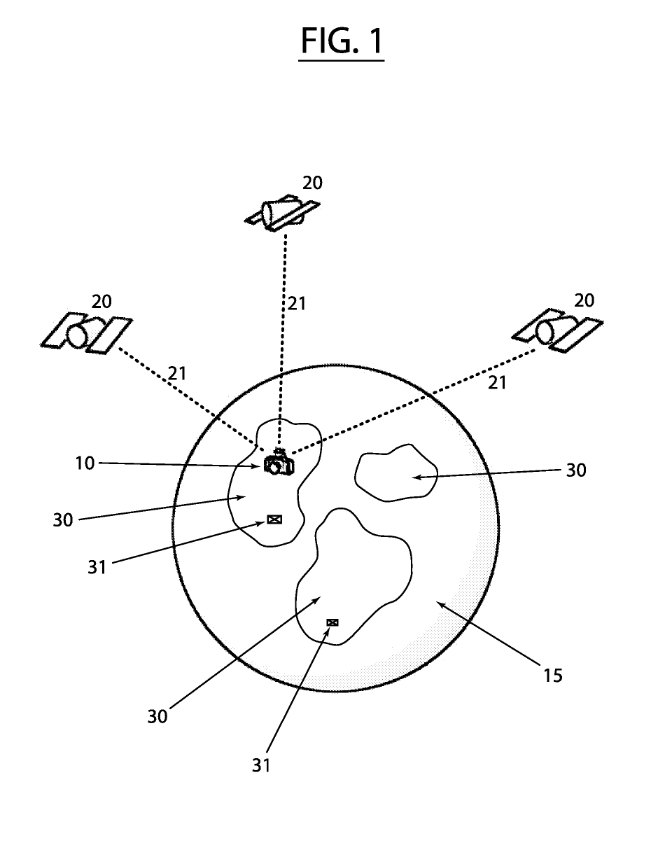

FIG. 1 of the present disclosure may illustrate the earth 15, having satellites 20 which are able to transmit radio signals 21 by which a locational fix on the earth may be obtained by a device on or near the earth; for example, satellites of the global positioning system GPS.

Figure one also depicts a photographic device 10 or system of photographic devices, cameras, lighting equipment, wireless control systems, and the like being present on or near the surface of the earth.

One or more regions 30 having geographic confines on the earth are depicted. Included also are optionally exclusion areas 31 on the earth, which may be the confines of specific areas within a region normally allowing for the operation of radio communication devices but within the exclusion areas 31 the operation of radio communication devices is not desired or not allowed, for example but not limited to military installations, areas conducting explosive blasting operations, and the like.

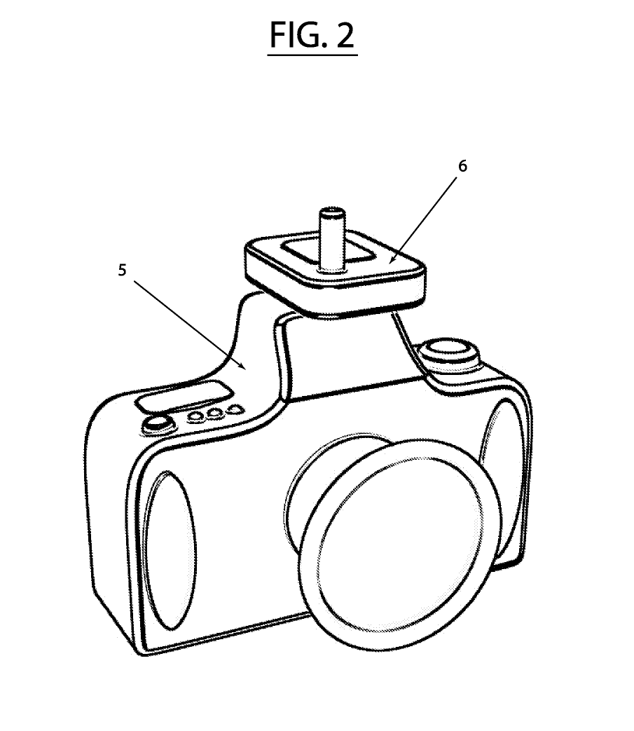

FIG. 2 of the present disclosure may illustrate an example camera system or photographic device, which may be embodied in many different forms beyond the specific form illustrated.

For example, a GPS reception functionality may be provided inside a camera body 5, or within an accessory device 6 which is electrically connected to or otherwise in communication with a camera body 5 (using light signals for example). The connection or communication may be via a hot-shoe connector or other data port accessible on the camera body 5 or accessory device 6.

One or more radio systems may be provided inside a camera body 5, or within an accessory device 6 which is electrically connected to or otherwise in communication with a camera body 5 (using light signals for example). The connection or communication may be via a hot-shoe connector or other data port accessible on the camera body 5 or accessory device 6.

Additionally, all or a portion of the GPS hardware and/or radio system(s) hardware may be provided within or external to a lighting device such as but not limited to a hand held battery operated flash, a studio lighting unit, or other device. Possible devices having a portion of the GPS hardware and/or radio system(s) hardware may also include camera positioning equipment—yaw, tilt, physical positioning motors, lens focus or zoom controllers, and the like.

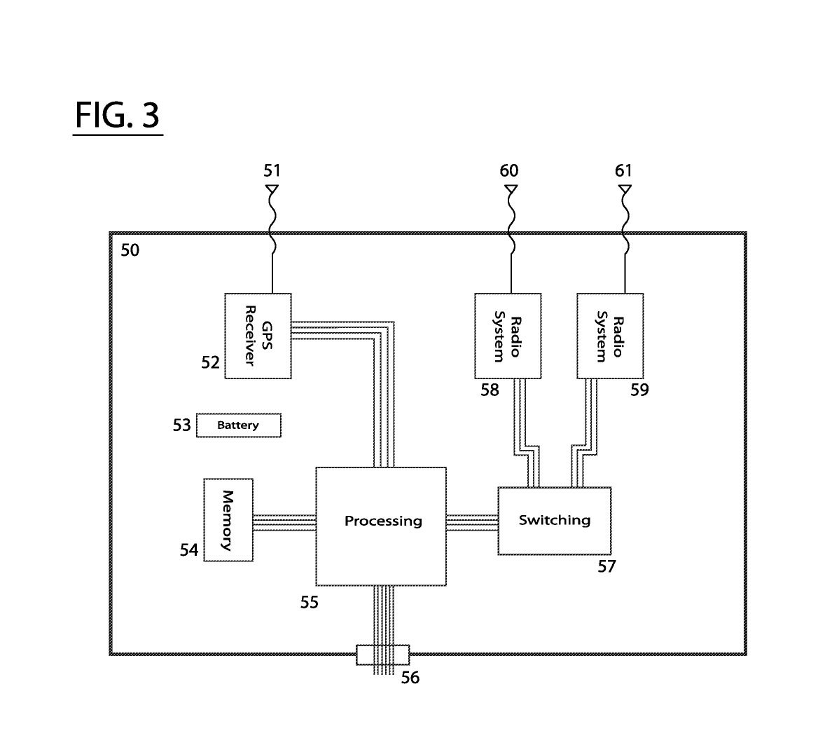

FIG. 3 of the present disclosure illustrates an exemplary simplified block diagram/schematic of the internals 50 of a device which may include all or a portion of the various hardware described within the present disclosure. The device may be any of or any combination of the devices previously mentioned. Portions of the illustrated hardware may be placed across a plurality of systems, devices, enclosures, or components, such that the portions of hardware are able to work together, communicate together, or otherwise accomplish the method or comprise in whole or in part the system described by the present invention. FIG. 3 includes only primary components. It is clear to anyone skilled in the art of electronic circuit design that additional components are required such as capacitors, resistors, filters, antenna balancing components, crystals, oscillators, clocks, amplifiers, isolators, voltage regulators or converters, shielding components, etc.

It is also clear that various changes may be made to the illustrated diagram of FIG. 3 including more or fewer of any component or component sub-assemblies, various means of power supply, switching, memory, or the like.

The illustration of FIG. 3 may include: One or more GPS reception hardware 52 having an antenna element 51 capable of receiving signals from the GPS system. Alternately or in addition to, this hardware may include other hardware required to obtain a positional fix as previously described via means other than the GPS system, for example but not limited to the reception of local radio or television station identifiers, cellular phone signals, signals from navigation beckons, and so on. The reception hardware 52 is electrically connected to a processing hardware 52 and is supplied with operating power from within the device 50 or from an external source.

A memory 54 is provided such as but not limited to an EEPROM which is non-volatile and is in communication with a processing means 55. The memory 54 may be included within the processing means such as EEPROM registers included within a microprocessor. The memory may be used to store geographic data relating to the confines of various regions, as well as the parameters or sequence of events required to cause one or more radio systems to operate within the legal regulatory parameters of a given region. The memory may also store the geographic data relating to exclusion areas. The memory may also store the most recent location fix, or a history of locational fixes. The memory is supplied with power if required.

A processing means 55 such as a microprocessor, a collection of discrete components, a collection of microprocessors, field programmable gate arrays (FPGA's), or other hardware capable of handling logical operations, or any combination there of The processing means may be dedicated to the function of the present invention, but may also provide other functions for a photographic device—for example, the primary processor of a digital camera system may also perform the required function of the processing means 55 of the present invention. The processor is provided externally or internally with a crystal oscillator, resonator, resistor-capacitor circuit, or other hardware capable of providing a clocking signal to the processing means 55. The processing means 55 may share the clock source with any of the other components of the present invention, or may derive the clock source from any of the other components of the present invention or another appropriate clock source provided internal or external to the photographic device.

An external connector or connectors 56 is optionally provided to allow communication via electrical connection, optical connection, or other useful signaling means with other devices such as a camera system or a camera lighting device or other accessory used together with a camera system or lighting device.

This connector 56 may also be used to communicate between two or more different devices if the different devices each include a portion of the hardware and/or processing means required by the present invention, or may derive useful function by communicating with the present invention, or where the useful invention may derive useful function by communicating with another device. The connector 56 may also be used to supply power to the present invention or a portion thereof from a power source external to the present invention.

A switching means 57 is optionally provided which may be physical switches, discrete components such as multiplexing or transistor components, relays, or other logical hardware or data communication interfaces which allow a processing means 55 to switchably or selectively enable or disable one or more radio communication devices 58, 59, or others. The switching means 57 may also be used to route various configuration parameters to a radio communications device which may relate to transmit power level, frequency, duty cycle, protocol, or other useful parameters used by a radio communications device.

At least one radio system 58 is provided which may allow a camera system, camera lighting device, or other photographic device to communicate with other devices wirelessly via radio signals. The radio system may be a radio transmitter, radio receiver, radio transceiver, or other hardware which makes possible the sending and/or receiving of radio signals, the radio signals may for example but not limited to, include commands to activate other equipment in synchronization with an event (such as the activation of a camera shutter), commands to configure other equipment, commands to query settings, status, or other data from other equipment, or the passive reception of radio signals which are useful to the camera system, lighting system, or photographic device, or any combination thereof.

The radio system 58 includes a frequency crystal or has access to a frequency source used to set directly or via reference a transmission and or reception radio frequency used by the radio system.

The radio system 58 is supplied with power similar to that of the other hardware previously described.

The radio system 58 is provided with an antenna element 60 which may protrude to the exterior of the device or may be included internally to the device. The antenna element used to radiate and/or receive radio signals to/from free space. The antenna element being of suitable tuning characteristics to send and/or receive the various characteristic radio signals of radio system 58.

Optionally, one or more additional radio systems 59, or additional portions of a first radio system 58 which enables the device to communicate radio signals adhering to different standards, protocols, or regulatory requirements may be provided. The second radio system 59 may be completely separate from the first radio system 58 having its own crystal or frequency reference and configuration or signal lines; or the second radio system 59 may include only a portion of additional or different components in one or more aspects of the radio system 58, in such case, the plurality of radio systems may share some components while having some components separate.

For example, a radio system 58 may be provided based around a CC1101 radio transceiver chip, available commercially from Texas Instruments. The CC1101 is capable of being programmatically set to a variety of transmission power levels and frequencies by a processing means such as that of 55 provided. In one region, the radio system 58 may need to transmit at a frequency of 915 MHz, while in another region, the radio system 58 may need to broadcast at 869 MHz. In such case, it is possible that two different crystal oscillators are required to provide an intermediate frequency capable of being sampled by a phase locked loop (PLL) to equal the desired transmit frequency. In such case, the second radio system or radio system components 59 may only include a second crystal oscillator tuned to the appropriate frequency, and switching means 57 is able to selectively connect the appropriate crystal oscillator to the radio system corresponding to the desired transmit frequency, and as directed by processing means 55.

It is possible also that the plurality of radio systems 58, 59, or others must be completely independent as their signaling or protocol may be substantially different. For example, in one region it may be desirable to use 915 MHz supplied by a first radio system 59 which is embodied around a CC1101 radio module. In another region it may be desirable to use 2.4 GHz which may be supplied by a second radio module such as a CC2400 available commercially from Texas Instruments, with the different radio modules being supplied by their own power supplies and having their own crystal oscillators or frequency reference.

A second radio system 59 may be provided optionally with a second antenna element 61 which may protrude to the exterior of the device or may be included internally to the device. The second antenna element 61 used to radiate and/or receive radio signals to/from free space. The second antenna element 61 being of suitable tuning characteristics to send and/or receive the various characteristic radio signals of radio system 59.

A battery power supply 53 may be provided optionally to allow the present invention or a device associated with the present invention to operate normally. The battery power supply may also provide backup power supply to the present invention if a primary power supply normally drawn externally or from another device is not available. The battery power supply may allow the present invention to obtain a locational fix even if the primary power to the present invention or a device associated with the present invention has been turned off by a user.

It is possible that a plurality of radio systems may use a single antenna element, or it is possible that a single radio system may be switchably able to use a plurality of antenna elements.

The radio systems will require an appropriate power supply similar to the other hardware previously described.

The radio system may communicate via any characteristic radio signal or signals including but not limited to amplitude modulation, frequency modulation, on-off-keying (OOK), frequency shift keying (FSK), frequency hopping, direct frequency spread spectrum, wide band, narrow band or others, and may involve the use of all or portions of various protocols including but not limited to ZigBee, protocols enabling a device to join or otherwise participate in a mesh network, WiFi, BlueTooth, or others. The radio system may use all or portions of the technology typically used in Radio Frequency ID (RFID) applications for wireless communications.

Summary

Based upon the present disclosure, it will be clear to anyone skilled in the art of electronic circuit design and/or radio transmitter design and/or radio antenna design and/or the implementation of navigational fixing systems and/or embedded system design that various portions of the present invention described by the present disclosure may be added to, subtracted from, or altered in various ways while keeping within the spirit and scope of the present invention. Based upon the present disclosure it will be clear that it is possible to integrate any or all of the portions of the present invention, individual hardware of the present invention, or hardware assemblies of the present invention, or hardware substantially similar to that discussed, or hardware providing functionality substantially similar to that discussed, either internally or externally to any device, circuit board, or apparatus, where the various hardware or any appropriate portion there of is able to communicate directly, electrically, optically, via connector, port, cord, connection or otherwise; which collectively provide the useful ability to configure a means of communicating wirelessly using radio signals to or from a camera body, camera flash unit, studio flash unit, camera remote control unit, camera control system, camera management system, a personal computer, an external device such as a video display, an external device such as a printer, an external device such as a data storage device, an external device such as a camera positioning device, other device having useful function in or related to the field of photography, or any combination thereof; and having the characteristics of the communicating wirelessly using radio signals related to a locational fix on or near the surface of the earth; and those characteristics of the communicating wirelessly using radio signals meeting the applicable laws or regulations for the locality corresponding to that of the locational fix.

What may be claimed may be:

1. A method of setting at least one parameter of a radio communications system, the method comprising;
obtaining a locational fix;
relating a locational fix to a region;
referencing a region to at least one parameter;
configuring a radio communication system based on the at least one parameter.

2. The method of claim 1 wherein the a radio communications system is coupled to a photographic device.

3. The method of claim 1 wherein the a radio communication system is comprised within a housing of a photographic device.

4. The method of claim 1 wherein the a locational fix is based on at least one signal received from at least one global positioning satellite.

5. The method of claim 1 wherein the a locational fix is based on at least one signal received from at least one cellular telephone tower.

6. The method of claim 1 wherein the a locational fix is based on at least one signal received from a station identification of at least one radio station.

7. The method of claim 1 wherein the a locational fix is based on at least one signal received from a station identification of at least one television station.

8. The method of claim 1 wherein the a locational fix is stored in a non-volatile memory of a photographic device.

9. The method of claim 1 wherein the a region corresponds to an exclusion area.

10. A method of setting at least one parameter of a radio communications system, the method comprising;
powering a GPS receiver;
obtaining a locational fix based on at least one signal from a GPS receiver;
referencing a locational fix to a location inside a geo-fence of a region;
referencing at least one parameter of a region;
configuring a radio communications system of a photographic device based on the at least one parameter.
